(19) United States
(12) Patent Application Publication
(10) Pub. No.: US 2003/0078918 A1
(43) Pub. Date: Apr. 24, 2003

(54) Method, apparatus and system for file sharing between computers

(76) Inventors: Todd J. Souvignier, New Orleans, LA (US); Valentin Kantchev, Glendale, CA (US); Kalin Georgiev Toshev, Glendale, CA (US)

Correspondence Address: Brull Piccionelli Sarno Braun & Vradenburgh, Suite 2350, 1925 Century Park East, Los Angeles, CA, 90067, US

(21) Appl. No.: 10/210,673

(22) Filed: Jul. 31, 2002

Related U.S. Application Data
(60) Provisional application No. 60/335,102, filed on Oct. 23, 2001.

(51) Int. Cl. G06F 7/00

(52) U.S. Cl. 707/3

(57) ABSTRACT

Embodiments of the present invention are directed to a file sharing system, method and apparatus which operate on a network and provide peer to peer file sharing. The file delivery system receives data files from third parties, encrypts the data and stores the file in a database. Once the file has been stored, the file delivery system creates ‘clone’ identifiers, or variant target query terms for the file, wherein the clone identifiers are shortcuts or aliases for the file identification that create a set of variations upon which a file can be identified. The ‘clone’ identifiers are stored in a database and are associated with the specific file. Upon request from a user for the file, the file is transmitted to the user. In addition, tracking software is transmitted with the file such that the subsequent downloading of other files from a third party to the user can be monitored and targeted advertisements can be displayed.

### RELATED APPLICATION

This application is related to, and claims priority from, U.S. patent application, entitled Method, Apparatus and System For File Sharing Between Computers, Serial No. 60/335,102 filed Oct. 23, 2001, and is fully incorporated herein by reference.

### FIELD OF INVENTION

The present invention is directed to a file sharing system, method and apparatus for use on a network. More specifically, a peer to peer file sharing system that provides authorized copies of content files for transfer between computers on a network, wherein the ability to locate the file on the network is enhanced by the creation of variable identifiers associated with the content file.

### BACKGROUND OF THE INVENTION

Wide area networks, such as the Internet or World Wide Web (“WWW”) have created a new marketplace for goods and services, and further have created the opportunity for users throughout the world to exchange information. Indeed, performers and artists, well known and unknown, have utilized the networks to expose their creative works, for example, music, photographs, and writings, to the world.

In addition to merely providing information that a user can view, the concept of file sharing was introduced. To facilitate file sharing among users, secondary networks have been created that allow for the direct sharing of files between users. In general, the secondary networks, or file sharing networks, allow participating users to access the computers of other participating users to retrieve desired files that have been stored by the user and designated as a shared file. The ‘shared’ files are typically files of general interest, such as, music, photographs, software programs and the like.

The secondary networks operate in conjunction with the WWW and other wide area networks, and thus, a fluidity of network communication is maintained. Indeed, searches performed by users on the secondary networks can retrieve search results from other secondary networks and from wide area networks. Thus, access to the vast amount of information available on the wide area networks is not lost by the user.

A problem with the operation of file sharing networks is that no control exists regarding how the shared files are entered into the network, or originally obtained. Thus, currently, many shared files are originally pilfered from chat rooms, bulletin boards, or from other web sites. As such, violations of laws occur as these files are transferred and distributed among users. Indeed, lawsuits regarding copyright and trademark violations are proliferating. Thus, artists seeking to introduce their work to the world, find that unauthorized copying and alteration of the work frequently occurs. Further, if the owners intend to only distribute their works for a fee, the authorized distribution of these works fails to provide any monetary compensation to the owner. Additionally, as the files are inappropriately obtained and distributed, the owner of the file is often not credited with the work, thereby completely negating most benefits normally received from creating the work and making it available to others.

A need in the industry exists for a file sharing system that allows the owner of the content file, or work, to voluntarily place the work within the system, thereby ensuring the end user that no violations of law are occurring by retrieving and distributing the work. A further need exists for a file sharing system that can locate works resident on a network, which are registered within the system for distribution. A still further need exists for a system that deters the transfer of unlicensed works and that make licensed works more readily available.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the present invention.

FIG. 2 illustrates the file sharing system in accordance with a preferred embodiment of the invention.

FIG. 3 is a block diagram of creating clone identifiers or variant target terms in accordance with preferred embodiments of the present invention.

FIG. 4 is a block diagram of a process for software delivery to a user for the distribution of data files in accordance with preferred embodiments of the invention.

FIG. 5 is a block diagram of the process for tracking and monitoring deployed content files in accordance with preferred embodiments of the present invention.

FIG. 6 is a block diagram of load balancing in accordance with preferred embodiments of the present invention.

### SUMMARY OF THE DISCLOSURE

Embodiments of the present invention are directed to a file sharing system, method and apparatus which operates on a network and provides peer to peer file sharing. Overall, a file delivery system receives data files from third parties, wherein these files are intended by the owner of the file to be shared with other users. Upon receipt of the data file, the file delivery system encrypts the data to secure the file and stores the file in a content database.

Once the file has been stored, the file delivery system creates ‘clone’ identifiers, or variant target query terms for the file, wherein the clone identifiers are shortcuts or aliases for the file identification that create a set of variations upon which a file can be identified. Clone identifiers are created via a set of rules applied to the filename and any metatags stored in the file. The ‘clone’ identifiers are stored in a database and are associated with the specific file. In some preferred embodiments, a multitude of identical databases exists which store the clone identifiers for more effective distribution, thereby reducing the ability of the database content to be blocked.

After the database of content has been created, the database is made accessible to various networks for searching by the users. When a user enters key words for searching, the file delivery system searches the database for words matching, in whole or in part, to the file identifiers, including the clone identifiers in the database. If a file is determined to be a match for the user's search, identification of the file is presented to the user.

Upon request from the user, the file is transmitted to the user computer from the file delivery system. When the user initially plays or views the file, a rights acquisition page is transmitted to the user. The rights acquisition page displays licensing terms for use of the requested file. In addition to transferring the license to the user, tracking software is also transmitted. If the user refuses to accept the tracking software, the user is still allowed to license the downloaded data file, upon agreeing to the terms of the license.

The tracking software is a monitoring and reporting software that monitors specified activities of the user. In particular, the tracking software monitors a user's access to other networks, including third party file sharing networks, in conjunction with downloading a file from the other networks.

Upon identification of these conditions, the tracking software reports the file name and file attributes of the downloaded file to the file delivery system. In some preferred embodiments, the file delivery system searches a second database that contains targeted files to determine whether any of the targeted files can be forwarded to the user, wherein the targeted files relate in some manner to the downloaded file. It is to be understood that the file delivery system can predetermine the targeted files to be forwarded depending upon the subject matter of the file downloaded from the file sharing software. In other preferred embodiments, the file delivery system searches the databases of affiliates or partners in the system.

In addition to downloading content from the content database, the file delivery system separately tracks copies of the downloaded content which are subsequently transferred by the user to other users. To track these additional copies, the file delivery system polls the networks and locates all of the copies of its data files. Once the file delivery system has located the copies of its data files, the file delivery system ranks the accessibility of the data files based, in part, upon the type of system that stores the file. In this regard, if the file delivery system is overloaded with requests for a particular file, the file delivery system can direct the user to one of the third party locations for download. If there is no location acceptable for substitute downloads, the file delivery system directly delivers the requested data file to the user.

Further, to expand the file delivery system's communication with other networks, the file delivery system injects itself into other networks by collecting lists of other hosts that exist on other networks. To collect new host lists, the file delivery system accesses other network nodes, or reflectors and copies the host list listed at that reflector. The file delivery system then contacts the hosts listed on the list, via the computer, and identifies itself as an existing host.

A feature of preferred embodiments of the invention is the creation of variant target terms. An advantage to this feature is that a user is not required to identically match a file name, or file identifiers in searching for a specific file or a file contained within particular subject matter. A further advantage to this feature is that the file can more readily be located and thus, becomes more accessible to users.

Another feature of preferred embodiments of the invention is the ability to track the files transferred among network users and rank the accessibility of the files. An advantage to this feature is the ability of the file delivery system to transfer load to another location by directing a user to one of the third party locations for download, thereby reducing load on the file delivery system and cost to the file delivery system

A still further feature of preferred embodiments of the invention is the injection of the file delivery system into other networks via collecting host lists from other network reflectors. An advantage to this feature is that the new host becomes aware of the file delivery system, such that, searches conducted on the host computer can now access the file delivery system and therefore, its database. Another advantage to this feature is that the files in the file delivery system become accessible to a wider group of users.

Another feature of preferred embodiments of the invention is that the file delivery system can track download activity of users. An advantage to this feature is that the file delivery system can transmit files related to the files being downloaded by the user from any computer or network, such as, marketing files. A still further advantage to this feature is that the file delivery system can determine more popular or desired files as it can track the number of times that a file is transferred. A further advantage to this feature is that the file delivery system can provide targeted advertisements at the place and time of the downloading of the file.

A still further feature of preferred embodiments is the generation of the variant target identifiers for each content file results in the creation of a population of variant target identifications in the search result list. The advantage to this feature is the increased likelihood that a user will be exposed to the underlying content file.

A further feature of preferred embodiments is that the number of created file identifiers can be increased or decreased dynamically based on population levels of competing content on the network. An advantage to this feature is that the file sharing system can operate ecologically, that is, the system can monitor the number of identifiers required to achieve distribution of the content file and respond by producing a population level of identifiers that does not overload the shared network.

Another feature of preferred embodiments is that the monitoring and tracking means identifies the file creation activity and records the relevant file information upon receipt of the downloaded file by the user computer. An advantage to this feature is that the tracking and identification of the newly downloaded content is instituted only upon the downloading of the file and is not monitoring search or query information, thereby being able to more effectively collect relevant information regarding a user's selections as the information is based upon an actually downloaded file, and thus, targeted information can be delivered to the user without creating a user profile and without requiring the user to be authenticated on the system.

The above and other features and advantages of embodiments of this invention will be apparent from the following more detailed description when taken in conjunction with the accompanying drawings of illustrative embodiments. It is intended that the above advantages can be achieved separately by different aspects of the invention and that additional advantages of this invention will involve various combinations of the above independent advantages such that synergistic benefits may be obtained from combined techniques.

### DETAILED DESCRIPTION OF THE PREFERRED EMBODIMENT

Preferred embodiments of the instant invention operate on a network, such as, for example, the Internet or World Wide Web (“WWW”), or any other type of network system, including, a peer-to-peer network, an internet or an intranet.

Hardware Environment:

Preferred embodiments of the present invention operate on a network system 10 including at least two client or user computers 12, at least one affiliate or partner computer 14 and a file sharing system 16 coupled for communication there between, generally represented at 18. It will be understood that further embodiments may employ any suitable number of user, and affiliate or partner computers, or may eliminate the affiliate or partner computer. The network system 10 may comprise a closed or intranet configuration, an open or public-access network configuration or combinations of such configurations, as is well known in the art. In an Internet embodiment, the network system 10 comprises a combination of a large number of interconnected internets and intranets, including third party file sharing systems. For purposes of simplifying the present disclosure, the various hardware components (for example, host servers, routers, connectors) and software necessary for communication between computers on the network system are not described herein in detail. Such hardware and software are well within the scope of one of ordinary skill in the art and are at least partially dependent upon the type of network system employed and the desired application of use.

The user computer 12 may comprise any suitable network device capable of communicating with other network devices in the network system. In preferred embodiments, the user computer 12 comprises a programmable processor capable of operating in accordance with programs stored on one or more computer readable media (for example, but not limited to floppy disc, hard disc, computer network, random access memory (RAM), CD-ROM, or the like), a display device for providing a user-perceivable display (for example, but not limited to visual displays, such as cathode ray tube (CRT) displays, light-emitting-diode (LED) or liquid-crystal-diode (LCD) displays, plasma displays or the like, audio displays or tactile displays), and a user input device (for example, but not limited to, a keyboard, mouse, microphone, or the like) In one preferred embodiment, the user computer and advertiser computer comprise a personal computer system having a CRT display, a keyboard and a mouse user-input device.

The user computer 12 is controlled by suitable software, including network communication and browser software to allow a user to request, receive and display information (or content) from or through a partner computer 14 on the network system 10. In preferred embodiments, the user computer 12 employs a program, such as a browser, for displaying content received from other network devices, such as a partner computer 14, or a file sharing system 16.

The partner computer 14 may comprise any suitable network device capable of providing content (data representing text, hypertext, photographs, graphics video and/or audio) for communication over the network. In preferred embodiments, the partner computer 14 comprises a programmable processor capable of operating in accordance with programs stored on one or more computer readable media (for example, but not limited to, floppy disks, hard disks, random access memory RAM, CD-ROM), to provide content for communication to another network device. The partner computer 14 may comprise, for example, but is not limited to, a personal computer, a mainframe computer, network computer, portable computer, personal data assistant (such as, Palm Inc.'s Palm Pilot), or the like. The partner computer 14 may include one or more internal data storage devices (not shown) or may be coupled to an external data storage device 20, computer or other means. In addition to communicating with a user computer 12, the partner computer 16 is also in electronic communication with the file sharing system 16.

The file sharing system 16 may comprise any suitable network device capable of processing information and providing content (data representing text, hypertext, photographs, graphics video and/or audio) for communication over the network. In preferred embodiments, the file sharing system 16 may comprise, for example, but is not limited to, a personal computer, a mainframe computer, network computer, portable computer, personal data assistant (such as, a Palm Inc.'s i705), or the like. The file sharing system 16 is similar to the user computer 12 and partner computer 14, and thus, the descriptions set forth above for these devices 12, 14 is fully applicable with regard to the file sharing system 16.

General Description of Preferred Embodiments:

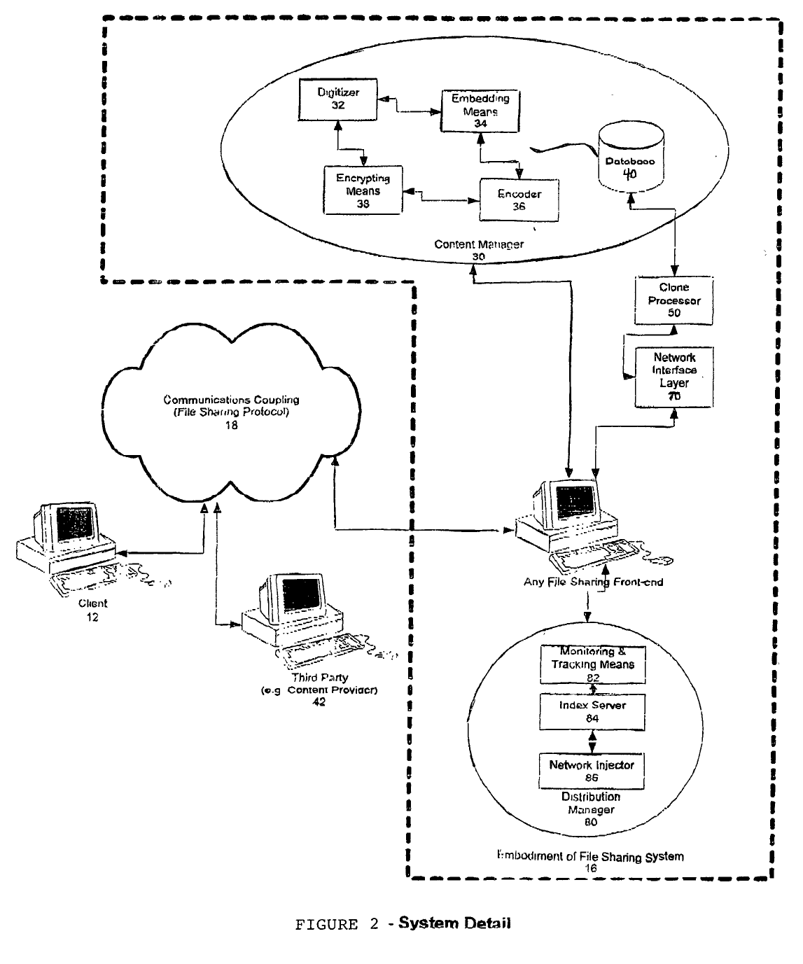

Embodiments of the present invention are directed to a method, apparatus and system for file sharing among user computers. In particular, embodiments of the present invention allow content from a content database to be shared among users and tracked by the system, wherein content related to the shared file can be transmitted as the file is shared, and statics on the file usage can be maintained. With reference to FIG. 2, embodiments of the file sharing system 16 comprise a content manager 30, a clone processor 50, a network interface layer 70, and a distribution manager 80.

The content manager 30 is a pre-distribution processor that comprises a digitizer 32, an embedding means 34, an encoder 36, an encrypting means 38 and a storage database 40. The content manager is configured to receive content, or data, files from third parties 42, such as, producers, graphic artists, writers, photographers, and the like. The data files include, but are not limited to, photographs, text files, graphic files, audio visual files, and the like. These files are intended by the owner of the file to be shared with other users. If any limitations are imposed on the use or distribution of the content, the content owner indicates such limitations upon the registration or inputting of the content file into the content manager 30, including, but not limited to, a fee amount for usage or viewing of the content.

Upon receipt of the data file, the content manager 30 prepares the file for distribution. To prepare the file for distribution, the content manager determines whether the file must be converted to digital format. If the file requires digitization, the file is processed through the digitizer 32, which converts the file to digital format. In some instances, file content will be received in a digitized format and thus, digitization will not be required. In some instances, once the file has been digitized, the file is embedded, via the embedding means, with URL scripts or commands. The URL script contains the address of a web page, wherein the web page and the web page content are displayed during the play of the file. After, or concurrently with the embedding of the URL script, the file is encoded by the encoder 36 to compress the data, for example, the video or audio, into distribution formats. The file is then secured via encryption, wherein the encrypting means 38 encrypts the file in accordance with any restrictions of usage and distribution that may be required by the content owner, including, for example, payment requirements for receipt of the file. Once the file has been encrypted, the file is stored in the storage database 40 for later access.

The clone processor 50 is a software application that creates a profusion of ‘clone’ identifiers, or variant target query terms for each content file, wherein the clone identifiers are shortcuts or aliases for the file identifiers associated with each content file. The clone processor creates a set of variations upon which a specific content file can be identified.

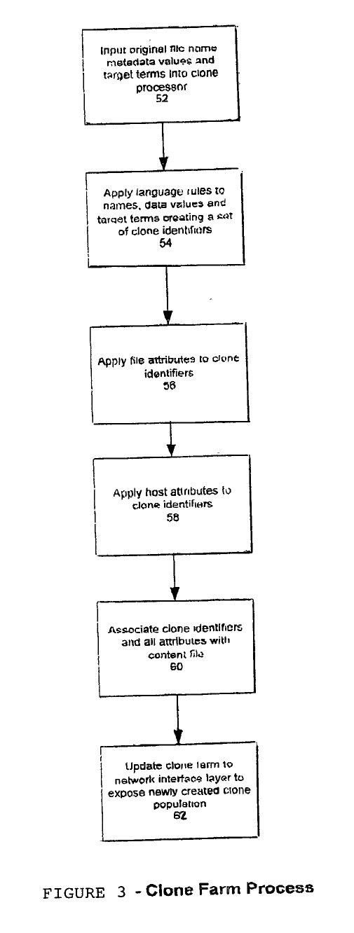

To create the clone identifiers, the clone processor applies a set of language rules to a set of target or query terms associated with the content file. With reference to FIG. 3, after the content file has been stored in the database, the original file name, metadata values and target terms, or query terms, are input into the clone processor by an operator 52. In some preferred embodiments, the target terms are provided with the file content by the content owner upon input of the file into the file sharing system, wherein these pre-identified terms are utilized by the clone processor. Target terms are terms relevant to the content, including, but not limited to, the title, artist, author, actor, producer, photographer, subject matter of content and the like. Additionally, target terms can also include terms that are unrelated to the content or terms that are general terms categorizing the content.

Once the set of target terms has been stored in association with the content file, the clone processor applies a set of language rules to the original file name, the metadata value, and each member in the set of target terms 54. The language rules create a plurality of clone identifiers, that is, variants or variations on the file names and tag data, wherein the clone variations are created by predefined routines to create variations, for example, on wording and punctuation, including inserting keywords and phrases, or variant words, phrases or characters into the file name and metadata fields, such as genre, title, and description. For example, in one preferred embodiment, the rules include adding punctuation to the filename, changing the order of the words or syllables comprising the filename, and adding words, such as metatag identifiers, to the filename. The clone identifiers are associated with the specific content file, wherein the clone identifier and associated file information is stored in a relational manner the database.

Once the set of clone identifiers has been created, file attributes are applied to the clone identifiers 56. In particular, each clone identifier is assigned file attributes, such as, file size, file type, bit rate, creation date and the like. In some preferred embodiments, the clone identifiers are multiplied by programmatically generated file attributes. To increase the number of variations in the file attributes, unique variations can be created using large ranges for each attribute. For example, a file size range of 1 kbyte to 10 Megabytes can be applied.

Finally, upon completion of the assignment of file attributes to each clone identifier, each clone identifier is assigned host attributes, such as, an IP address, connection speed, service provider, user name, host applications and the like 58. In some preferred embodiments, the clone identifiers are multiplied by programmatically generated host attributes. To increase the number of variations on the host attributes, unique variations can be generated by creating values from within the full value ranges of each parameter. For example, a range of IP addresses. The assignment or affixing of host attributes to the clone identifiers creates ‘spoofed hosts’, wherein each of the spoofed hosts redirects the user to the original content database via the clone processor. It is to be understood that in some preferred embodiments, file attributes and host attributes are not assigned to each content file, and in other preferred embodiments, such assignments are optional for the file attributes, the host attributes or any combination thereof.

Once the clone identifiers have been created, the clone identifiers and attributes are associated with both the original content file and the set of keywords or terms associated with the file 60. In this manner, a clone population or ‘clone farm’ is created, wherein each of the aliases appear as downloadable content to the users on a network, thereby increasing the likelihood that a particular content file will be presented to the user. Indeed, by creating the profusion of variant aliases, each content file can be exposed to the network numerous times, and these exposures can be grouped such that users requesting a targeted query or search term will receive large numbers of cloned variant entries in the search result list. Thus, a search request by a user computer results in the identification of the associated content file in the search result list with a high frequency, wherein each alias is presented to the user as associated with discrete content. The cloned variants in the search result list are returned to users in a manner such that multiple cloned entries will be ranked at and near the top of the search result list. The number of entries and the prominent positions of the entries increase the likelihood that the end user will select and download the content from the file sharing system. To activate, or expose the newly created clone population to the file sharing networks, the clone processor updates the clone farm's ‘image’, that is, available sets of clone populations to the network interface layer 62. In this manner, the aliases are exposed to the active networks. In other preferred embodiments, instead of creating file aliases or shortcuts, the clone farm will generate or synthesize search results datagrams such that a series of messages are displayed to the user.

In preferred embodiments, prior to creating the clone farm, the number of clones to be generated for each target term is input into the clone processor. In one preferred embodiment, an operator, or manager, of the file sharing system, manually inputs the information into the system. In other preferred embodiments, the desired number of clones are derived automatically by polling target networks for each target term and recording the number of results currently populating each term. In these instances, in some embodiments, the polling occurs continuously and interacts with the clone processor such that the clone farm populations levels are dynamically increased or decreased for each target term in accordance with the current population counts of competing content on the networks.

The network interface layer 70 an interface between the network, including third party file sharing networks, and the storage database. The network interface layer 70 provides a gateway to the networks and operates in conjunction with the clone processor 50 to identify and deliver original content data to users on the network. In preferred embodiments, the network interface layer 70 is not directly accessible by the user, but rather, is a single gateway through which requests for the content can be processed and directed to the clone processor 50, thereby facilitating the identification of the content associated with the alias and the uploading of that content from the storage database 40 to the user computer 12 by the clone processor 50.

The distribution manager 80 facilitates distribution of the content database, including the establishment of access to new distribution networks. Additionally, the distribution manager tracks previously downloaded content and monitors the content request load on the file sharing system such that, if necessary, more efficient avenues for the delivery of files can be identified. With reference again to FIG. 2, the distribution manager 80 comprises monitoring and tracking means 82, an index server 84 and a network injector system 86.

The monitoring and tracking means 82 is a software application that monitors pre-identified activities of the user; namely, the tracking software monitors when the user receives or downloads selected content files, such as, when the user is accessing third party file sharing software and downloading a file from the third party file sharing software. To perform these tasks, the monitoring and tracking software must be resident on the user computer. As such, the monitoring and tracking means is transmitted to the user upon the user's attempt to open a content file downloaded from the file sharing system.

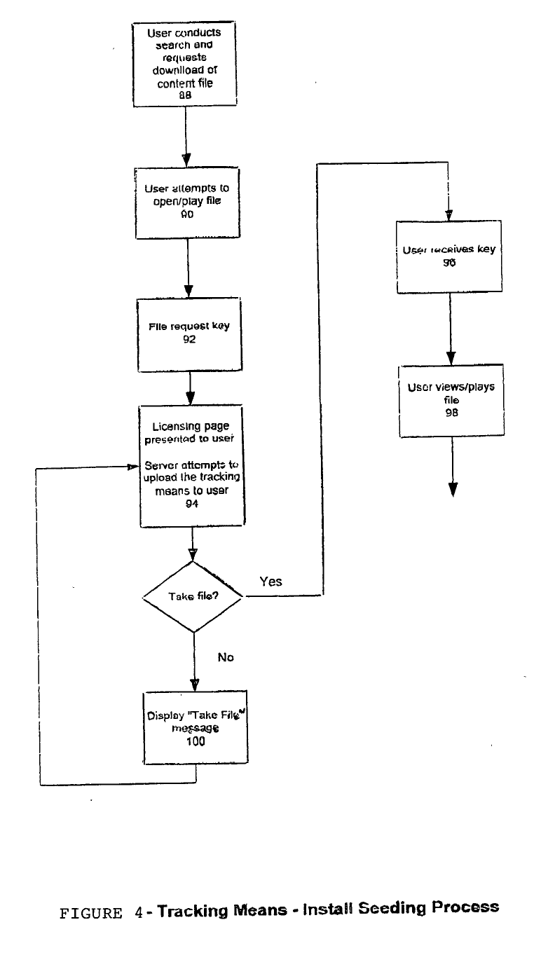

With reference to FIG. 4, in one preferred embodiment, a user has conducts a search and requests the downloading of a content file, such as, an audio or video file 88. Once the file is downloaded, the user attempts to play or open the file 90. To play or open the file, the content file must be ‘unlocked’ as it has been encrypted. The unlocking of the file requires a key, such as a digital rights management (“DRM”) key. The content file connects the user to the network, if the user is not already connected to the network, and transmits a request for the key to the DRM license server 92. Further, the user is presented with the licensing acquisition page for the particular content, wherein the licensing page commences the attempt to upload the monitoring and tracking software to the user computer 94. During the attempt to upload the monitoring and tracking software, a message, such as, a ‘take file’ message, is transmitted to the user computer advising of the attempted upload, and requests permission from the user to accept the software. If the user accepts the software, once the downloading and installation of the software are complete, the ‘unlock’ key is transmitted to the user 96. The user can now play or view the original content file and has also been ‘seeded’ with the monitoring and tracking software 98.

If the user does not accept the software, the provider server transmits the ‘take file’ message, wherein the transmission of the message includes an explanation of the benefits of accepting the software file 100. The server then re-attempts to upload the software file and repeats the transmission of the message requesting permission 94. This is repeated until the user accepts the software, or exits the network and file sharing system. In some preferred embodiments, the user is allowed to opt-out and not accept the software. In this instance, if the user refuses acceptance of the software file a predefined number of times, the license and key are forwarded to the user without the software file.

Overall, once the monitoring and tracking software is installed on the user computer, it automatically launches upon start-up of the user's computer, wherein the monitoring and tracking software runs in the background on the user's computer and thus, runs virtually invisibly to the user. Once the monitoring and tracking software resides on the user's computer, the software identifies and reports various user behavior; in particular, the user's activities on other third party networks, such as, downloading or copying files from the third party network. Upon identification of these conditions, the tracking software reports the file name and file attributes of the downloaded file to the file delivery system, including, but not limited to, title of the file, information from the file header metadata, file type and file source information. In addition to tracking the user's selected files from other third party networks, the file sharing system can monitor whether copies of any content files stored in the file sharing system that are downloaded from other networks are authorized distributions of the content files.

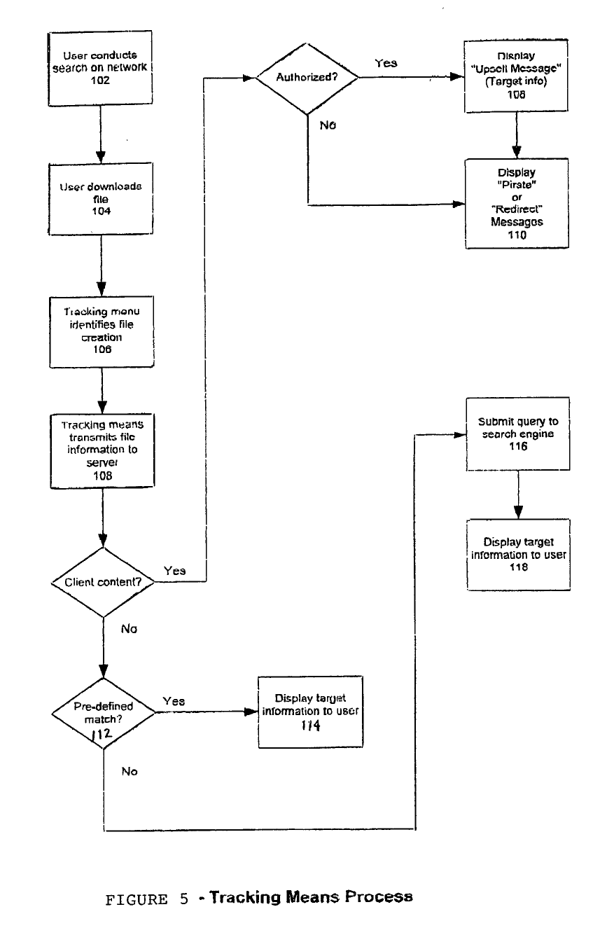

With reference to FIG. 5, in a preferred embodiment, a user connects to a network, wherein upon connecting to the network the monitoring and tracking software is automatically opened and executed on the user computer. The user utilizes the network to search for, and select, any content available for download on the network, wherein the user need not be selecting exclusively from content hosted by the file sharing system discussed in the preferred embodiments set forth herein 102. Upon review of the search results, the user selects content and downloads the selected content to the user computer 104. Upon receipt of the downloaded file, the monitoring and tracking software identifies the file creation activity and records the relevant file information 106. The file information is transmitted to the file sharing system 108, wherein the incoming file information is examined to determine whether the file name or metadata matches information corresponding to content stored in the content database 40, and therefore likely to be property of a client of the file sharing system. If the content is suspected as being a client-content match, the file information is compared to a list of “Authorized” client content, wherein content on the list is known to be distributed directly by the file sharing system, the client or a third party agent.

In addition to attempting to ascertain whether the content is authorized, in some preferred embodiments, upon receipt of the file information, the file delivery system utilizes the information to select target information to transmit to the user, including, but not limited to, messages, interactive web pages or advertisement relevant to the file being downloaded. The file delivery system searches a second database that contains targeted information previously identified with particular content files, or keywords, to determine whether target information can be forwarded to the user, wherein the targeted information relates in some manner to the downloaded file. If the content is authorized, that it is on the Authorized content list, target information associated with, or related to, the authorized content can be retrieved from the second database and transmitted from the provider computer to the user computer 108. In this manner, the content owner can indirectly reward the user for the selection of an authorized copy of the content, or can utilize the opportunity to convey other information to the user, such as, an advertisement, or direct the user to additional authorized downloadable content and purchases. For example, if a user is downloading a Star Trek video clip, the file delivery system might forward an advertisement for a Star Trek convention to the user.

If the content is not on the Authorized content list, target information, or a message, associated with, or related to, the content can be retrieved from the second database and transmitted to the user computer 110. In this manner, the content owner can alert the user that the downloaded copy is an unauthorized copy of the content, and can direct the user to authorized downloadable content and purchases. In one preferred embodiment, a standard or default message regarding copyright infringement and the like can be transmitted to the user. If the content is not suspected as being a client-content match, the file information is further compared to a list of predefined keywords or phrases 112. If a match is detected with regard to file information, target information associated with, or related to, the keywords or phrases can be retrieved and transmitted to the user computer 114. It is to be understood that the file delivery system could also predetermine the advertisements to be forwarded depending upon the subject matter of the file downloaded from the file sharing software.

If no match is made with keywords or phrases, in some preferred embodiments, the file sharing system searches target information databases 20 associated with affiliates or partners computers 14 in the system. The affiliates maintain a target information database containing interactive content, merchandise offers and other information. The file sharing system transmits the file title information to the search engine of the affiliate 116, wherein targeting information matching, or associated with the file title information is transmitted to the user as URLs 118. The URLs direct the user to dynamically generated pages that contain content, merchandise offers and other information relevant to the file title information.

If more than one affiliate returns results to the file sharing system, the file sharing system compares and weighs the sets of results in accordance with a plurality of criteria, including, but not limited to, the number of results, the relevance of each result item, prices associated with merchandise offers or the status of the affiliate's business relationship with respect to the file sharing system. Once the results have been weighted, the ‘best’ affiliate page is transmitted to the user. Selected URLs are then transmitted to the user so that the affiliate's target information, for example, advertisement, is displayed to the user.

In addition to downloading content from the content database, the file delivery system separately tracks all of the copies of the downloaded content which are subsequently transferred by the user to other users by storing information on the index server 84. As it is permissible for the users to share the files downloaded from the file delivery system, many copies of the file permeate the networks that were never directly downloaded from the file delivery system.

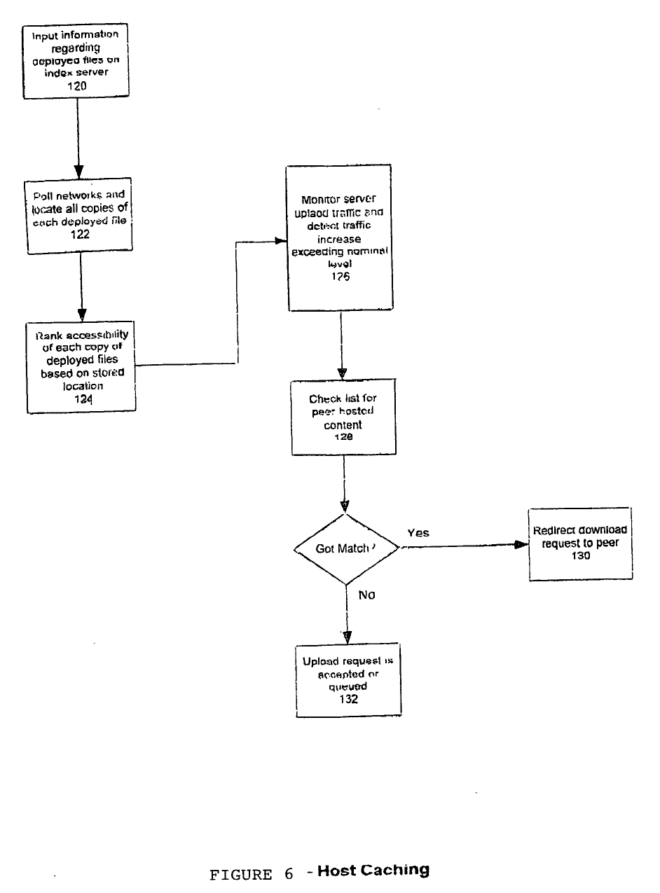

To track these additional copies, with reference to FIG. 6, in one preferred embodiment, information regarding each ‘deployed’ or downloaded content file is stored on the index server 120, wherein the information in the deployed list includes file attributes, such as, but not limited to, file name, file size, file type, header metadata content and the like. The file delivery system then polls the networks and locates all of the copies of the deployed data files included in the index server 122. The list of locations for each file is stored in association with the identification of each deployed file by any suitable means, including, but not limited to, buffer memory, a text file or a searchable database. Once the file delivery system has located the copies of its data files, the file delivery system ranks the accessibility of the deployed data files based, in part, upon the type of system that stores the file 124. The file delivery system monitors server traffic to determine whether the traffic, that is, the requests for the particular files, are exceeding a predefined level 126. In this regard, if the file delivery system is overloaded with requests for a particular file, the file delivery system can review the index server for the requested content 128. If a match, or multiple matches are found on suitable locations, the file delivery system directs the user to one of the third party locations for download, thereby reducing load on the file delivery system and cost to the file delivery system 130. If there is no location acceptable for substitute downloads, the file delivery system directly delivers the requested data file to the user 132. It is to be understood that redirection of traffic is based only upon requested content and is not redirected due to a general monitoring of the quality of service. It is to be further understood that the file delivery system only indexes content files registered within the system.

The network injector system seeks to expand the file delivery system's communication with other networks. To expand the communication with other networks, the file delivery system injects itself into other networks by collecting lists of other hosts that exist on other networks. In one preferred embodiment, to collect new host lists, the file delivery system accesses other network nodes, or reflectors. As practiced in the industry, the reflectors list the other hosts that communicate with that network. The file delivery system simply copies the host list. The file delivery system then contacts the hosts listed on the list, via the computer, and identifies itself as an existing host. In this manner, the new host is now aware of the file delivery system, such that, searches conducted on the host's computer can now access the file delivery system and therefore, its database. In preferred embodiments, network injection will be installed on multiple provider computers, wherein each of the provider computers will target a predefined section of a network to perform the injection function. In this manner, more efficient expansion of the file delivery system can occur without redundancy of effort by the system.

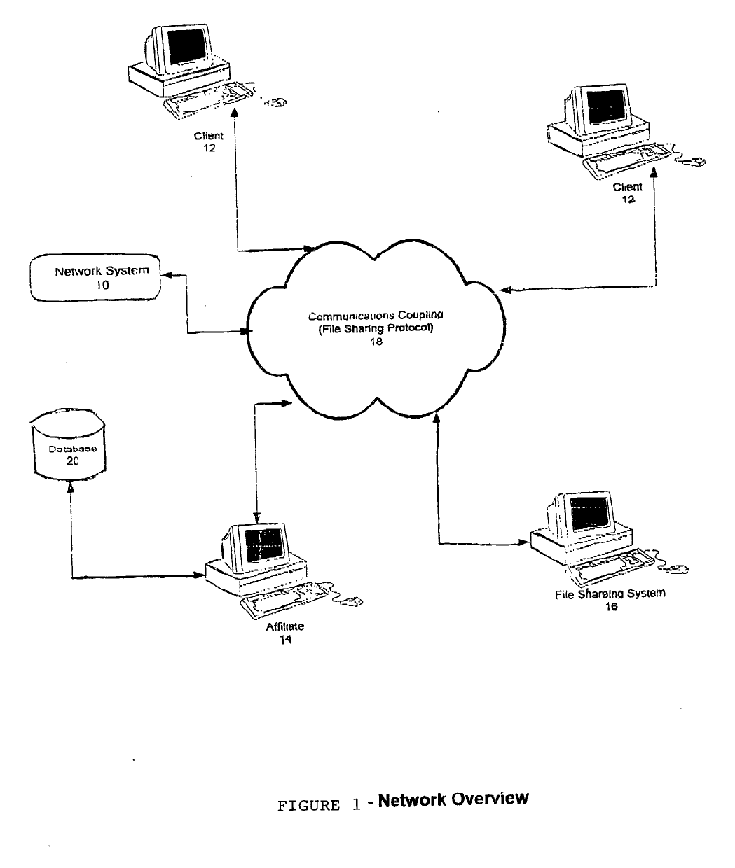

In operation, with reference again to FIGS. 1 and 2, prior to the file sharing network and its content database being exposed to other networks, the file sharing network receives content files from the owners of the content, wherein the content files are intended to be shared with other users. The received content is pre-processed and stored in a content database.

Once the file sharing network has sufficient content, the database of the file sharing network is exposed to other networks and made available to users. When a user accesses a network, the file sharing network, or some other network to which the file sharing network is known, and conducts a search for content on the network, the content database is reviewed for matches to the query terms input by the user. If matches are found, the matches, which include the clone identifiers associated with the query terms are presented to the user in the search result list. If the user selects one of the clone identifiers, the file sharing system transmits the request to the clone processor, wherein the clone identifier and the original content file identification is resolved. Once the content file is identified, the content file is downloaded to the user. When the user attempts to open or play the content file, the user is presented with a rights acquisition licensing page and the system further attempts to upload the monitoring and tracking software. Further, the content file transmits a request for a key to unlock the encrypted file.

If the user accepts the monitoring and tracking software, the monitoring and tracking software is uploaded to the user computer and the key is transmitted to the user such that the file can be opened. Once the monitoring and tracking software is uploaded to the user computer, the software remains open in the background on the user computer, wherein the software waits for new download activity from other networks by the user. If the user conducts further searches and downloads or transfers content from other networks, the new activity is reported to the provider computer, which utilizes the file information to select target information, such as, advertising, from the target information database or to transmit requests to affiliate or partner computer databases. If desired, the user can respond to the target information.

Although the foregoing described the invention with preferred embodiments, this is not intended to limit the invention. Rather, the foregoing is intended to cover all modifications and alternative constructions falling within the spirit and scope of the disclosure and the embodiments as described.

What we claim is:

1. A method of providing at least one data file from a database maintained by an operator to a user connected to the database by a network, the method comprising the steps of:
a) associating a target query term with a data file within a database,
b) producing a variant target query term by applying at least one variant rule to the target query term,
c) associating the variant target query term with the data file,
d) receiving a query for at least one of the target query term and the variant target query term from a user via a network,
e) responding to the query by providing the user with a listing of query hits, each query hit being associated with at least one of the target query term and the variant target query term,
f) receiving from the user a download request associated with a query hit, and
g) providing the data file to the user in response to the download request.

2. The method of claim 1 wherein in step (a) the target query term is related to at least a portion of the content of the data file.

3. The method of claim 1 wherein in step (a) the data file is an encrypted data file.

4. The method of claim 1 wherein in step (a) the data file is associated with at least one target query term selected from the group consisting of a file name, a file attribute and a host attribute.

5. The method of claim 4 wherein the file attribute is a tag value selected from the group consisting of a genre value, a title, a description, a file size, a file type, a bit rate and a creation date.

6. The method of claim 4 wherein the host attribute is selected from the group consisting of an IP address, a connection speed, a service provider, a user name and a host application.

7. The method of claim 1 wherein in step (b) the variant rule changes the spelling of the target query term to produce the variant query term.

8. The method of claim 1 wherein in step (b) the variant rule changes the punctuation of the target query term to produce the variant query term.

9. The method of claim 1 wherein in step (b) the variant rule adds at least one alphanumeric character to the target query term to produce the variant query term.

10. The method of claim 9 wherein the variant rule adds at least one word to the target query term to produce the variant query term.

11. The method of claim 1 wherein the target query term comprises a plurality of words and wherein the variant rule changes the order of the plurality of words.

12 The method of claim 1 wherein in step (b) a plurality of variant target query terms are produced.

13. The method of claim 12 wherein in step (b) the plurality of variant target query terms are produced by application of at least one variant rule to the target query term, and wherein in step (c) the plurality of variant target query terms are associated with the data file.

14. The method of claim 12 wherein in step (b) a plurality of variant target query terms are produced by application of a plurality of variant rules to the target query term, and wherein in step (c) the plurality of variant target query terms are associated with the data file.

15. The method of claim 12 wherein the number of the plurality of variant target query terms is specified by the operator.

16. The method of claim 12 wherein the number of the plurality of variant target query terms is determined by polling at least one target network for the target query term, determining the number of results populating the target query term, and providing a number of variant target query terms that is proportional to the number of results populating the target query term.

17. The method of claim 4 wherein after step (b) a variant rule changes at least one file attribute to produce a variant file attribute, and wherein after step (c) the variant file attribute is associated with the data file and with the variant target query term.

18. The method of claim 4 wherein after step (b) a variant rule changes at least one host attribute to produce a variant host attribute, and wherein after step (c) the variant host attribute is associated with the data file and with the variant target query term.

19. A method of providing a user with access to at least one data file, the method comprising the steps of:
a) receiving a request for a data file from a database,
b) uploading an application in response to a request activated by the request of step (a); and
c) installing the application on a computer operated by the user.

20. The method of claim 19 wherein in step c) authorization to install the application is requested prior to installation of the application on the computer.

21. The method of claim 20 wherein authorization is provided by the user and the application is installed on the computer.

22. The method of claim 20 wherein authorization is denied by the user and the request for authorization is repeated.

23. A method of accessing at least one data file, the method comprising the steps of:
a) requesting a data file from a database,
b) receiving an application in response to a request activated by the request of step (a), wherein the application is installed on a computer operated by a user after receipt thereof, and
c) receiving a key enabling the user to access the requested data file after installation of the application.

24. The method of claim 23 wherein in step b) authorization to install the application is requested prior to installation of the application on the computer.

25. The method of claim 24 wherein authorization is provided by the user and the application is installed on the computer.

26. The method of claim 24 wherein authorization is denied by the user and the request for authorization is repeated.

27. A method of delivering information to a user accessing a data file over a network, the method comprising the steps of:
a) identifying the data file accessed by the user;
b) providing the identification of the data file to a server,
c) comparing the identification of the data file with a database comprising a plurality of data files,
d) associating at least one data file of the database with the data file provided to the user, and
e) providing the associated data file to the user.

28. The method of claim 27 wherein step (b) further comprises providing notification to the server during or after provision of the data file to the user and prior to providing the associated data file to the user.
